(19) United States
(12) Patent Application Publication
(10) Pub. No.: US 2011/0144959 A1
(43) Pub. Date: Jun. 16, 2011

(54) FAST ANALYSIS METHOD OF STEADY-STATE FIELDS, FAST ANALYSIS PROGRAM OF STEADY-STATE FIELDS, AND RECORDING MEDIUM

(75) Inventor: Kenji MIYATA, Hitachinaka (JP)

(73) Assignee: Hitachi, Ltd.

(21) Appl. No.: 12/961,839

(22) Filed: Dec. 7, 2010

(30) Foreign Application Priority Data
Dec. 10, 2009 (JP) 2009-280415

(51) Int. Cl. G06F 17/10

(52) U.S. Cl. 703/2

(57) ABSTRACT

A fast analysis method of steady-state fields performs arithmetic processing over plural time steps, performs transient analysis on the basis of an equation having a time derivative term, obtains a physical quantity of an analysis object, and includes the steps of reading input data including a time average width necessary to perform time averaging on the physical quantity, a phase width of a fundamental wave corresponding to the time average width, or a time step width necessary to perform the time averaging, and finite element modeling data of the analysis object by the arithmetic device; obtaining a time-averaged physical quantity using the time average width, the phase width of the fundamental wave, or the time step width by the arithmetic device; and obtaining a steady-state field of the physical quantity through a correction of the physical quantity using the time average quantity by the arithmetic device.

### CLAIM OF PRIORITY

The present application claims priority from Japanese Patent Application JP 2009-280415 filed on Dec. 10, 2009, the content of which is hereby incorporated by reference into this application.

### FIELD OF THE INVENTION

The present invention relates to an analysis method of steady-state fields, an analysis program of steady-state fields, and a recording medium in which the analysis program of steady-state fields is recorded.

### BACKGROUND OF THE INVENTION

An example of conventional typical nonlinear magnetic-field analysis methods is an analysis method based on the finite element method, sometimes combined with an iterative solution technique based on the Incomplete Cholesky Conjugate Gradient (ICCG) method or with the Newton-Raphson method that sequentially corrects permeability. This method is described in, for example, the textbook entitled “Finite Element Method in Electrical Engineering” by Takayoshi Nakada and Norio Takahashi (Morikita Publishing, 1986).

When transient analysis is performed to obtain a solution of a differential equation that has a time derivative term and deals with a transient phenomenon, transient analysis is required to be performed over many time steps to obtain an intended steady-state field if a time constant is long in a time-decay term. In order to solve this problem, a technique called the time-periodic explicit error correction (TP-EEC) method (or simply called the EEC method) has been developed. This method is described in, for example, “Problems remained in practical usage of 2 dimensional electromagnetic analyses (3)” by Tadashi Tokumasu, Masafumi Fujita, and Takashi Ueda (United Study Group of Static Apparatuses and Rotating Machines in the Institute of Electrical Engineers of Japan, SA-08-62/RM-08-69, 2008) and “Improvement of Convergence Characteristic in Nonlinear Transient Eddy-Current Analyses using the Error Correction of Time Integration based on the Time-Periodic FEM and the EEC Method” by Yasuhito Takahashi, Tadashi Tokumasu, Masafumi Fujita, Shinji Wakao, Takeshi Iwashita, and Masanori Kanazawa (IEEJ Trans. PE, Vol. 129, No6, 2009, pp. 791-798).

The TP-EEC method, which directly utilizes the periodicity relevant to time, cannot correct a physical quantity of an analysis object unless transient analysis is performed over a half period or one period. Although the correction may be completed after performed about three times, calculation over about a 1.5 periods is required if a half-periodic boundary condition is satisfied and calculation over about three periods is required if a periodic boundary condition is satisfied before the correction is completed. In addition, a matrix equation has to be solved during one correction calculation, leading to a problem that a calculation cost (calculation time) for correction is relatively large. As stated above, the correction requires calculation to be performed over the 1.5 period or three periods. Therefore, if the period of a fundamental frequency component is very long, the correction takes a long calculation time and a decay field decays to some extend during the calculation time, resulting in a decrease in the primary effect of the TP-EEC method to obtain a steady-state field fast.

An object of the present invention is to provide a fast analysis method for obtaining a steady-state field in a transient analysis of a phenomenon expressed by a differential equation having a time derivative term.

### SUMMARY OF THE INVENTION

One aspect of a fast analysis method of steady-state fields in accordance with the present invention performs arithmetic processing over a plurality of time steps, performs transient analysis on the basis of an equation having a time derivative term, and obtains a physical quantity of an analysis object by an arithmetic device. The fast analysis method of steady-state fields includes the steps of reading input data including a time average width necessary to perform time averaging on the physical quantity, a phase width of a fundamental wave corresponding to the time average width, or a time step width necessary to perform the time averaging, and finite element modeling data of the analysis object by the arithmetic device; obtaining a time-averaged physical quantity using the time average width, the phase width of the fundamental wave, or the time step width by the arithmetic device; and obtaining a steady-state field of the physical quantity through a correction of the physical quantities using the time-averaged quantities by the arithmetic device.

Another aspect of the fast analysis method of steady-state fields in accordance with the present invention includes the steps of reading input data including a time average width necessary to perform time averaging on the physical quantity, a phase width of a fundamental wave corresponding to the time average width, or a time step width necessary to perform the time averaging, and finite element modeling data of the analysis object by the arithmetic device; obtaining a time-averaged physical quantity using the time average width or the time step width by the arithmetic device; and obtaining a steady-state field of the physical quantity through a correction of the physical quantity using the time average quantity by the arithmetic device.

A still another aspect of the fast analysis method of steady-state fields in accordance with the present invention performs transient analysis on a nonlinear magnetic field of an analysis object by the finite element method and arithmetic processing over a plurality of time steps. The fast analysis method of steady-state fields includes the steps of reading input data including a time average width necessary to perform time averaging on unknown variables employed in magnetic field analysis, a phase width of a fundamental wave corresponding to the time average width, or a time step width necessary to perform the time averaging, and finite element modeling data of the analysis object by the arithmetic device; obtaining time-averaged values of the unknown variables obtained through the transient analysis using the time average width, the phase width of the fundamental wave, or the time step width by the arithmetic device; and obtaining a steady-state field of the nonlinear magnetic field through a correction of the values of the unknown variables obtained through the transient analysis using the time average quantity by the arithmetic device.

A fast analysis program of steady-state fields in accordance with the present invention is a program in which a series of steps included in one of the above-mentioned fast analysis methods of steady-state fields is coded.

A computer-readable recording medium in accordance with the present invention is a medium in which the above-mentioned fast analysis program of steady-state fields is recorded.

The fast analysis method of steady-state fields in accordance with the present invention can obtain a steady-state field fast by a lower-cost calculation than the conventional TP-EEC method can.

### BRIEF DESCRIPTION OF THE DRAWINGS

FIG. 1 is a diagram showing processes of analysis based on a fast analysis method of steady-state fields in accordance with the present invention;

FIG. 2 is a graph showing time variations of the error from a theoretical solution in an example of numerical calculation in the second embodiment in accordance with the present invention;

FIG. 3 is two graphs showing time variations of x and y respectively in the example of the numerical calculation in the second embodiment in accordance with the present invention; and

FIG. 4 is a schematic view showing an example of an analysis system in which the first to fifth embodiments in accordance with the present invention are implemented.

### DESCRIPTION OF THE PREFERRED EMBODIMENTS

Embodiments of a fast analysis method of steady-state fields in accordance with the present invention will be described below. The fast analysis method of steady-state fields in accordance with the present invention performs arithmetic processing over plural time steps, performs transient analysis on the basis of an equation having a time derivative term, and obtains a physical quantity of an analysis object. The fast analysis method of steady-state fields in accordance with the present invention is carried out by a computer that is an arithmetic device. The results of the analysis are stored in a storage device and displayed on a display device.

### First Embodiment

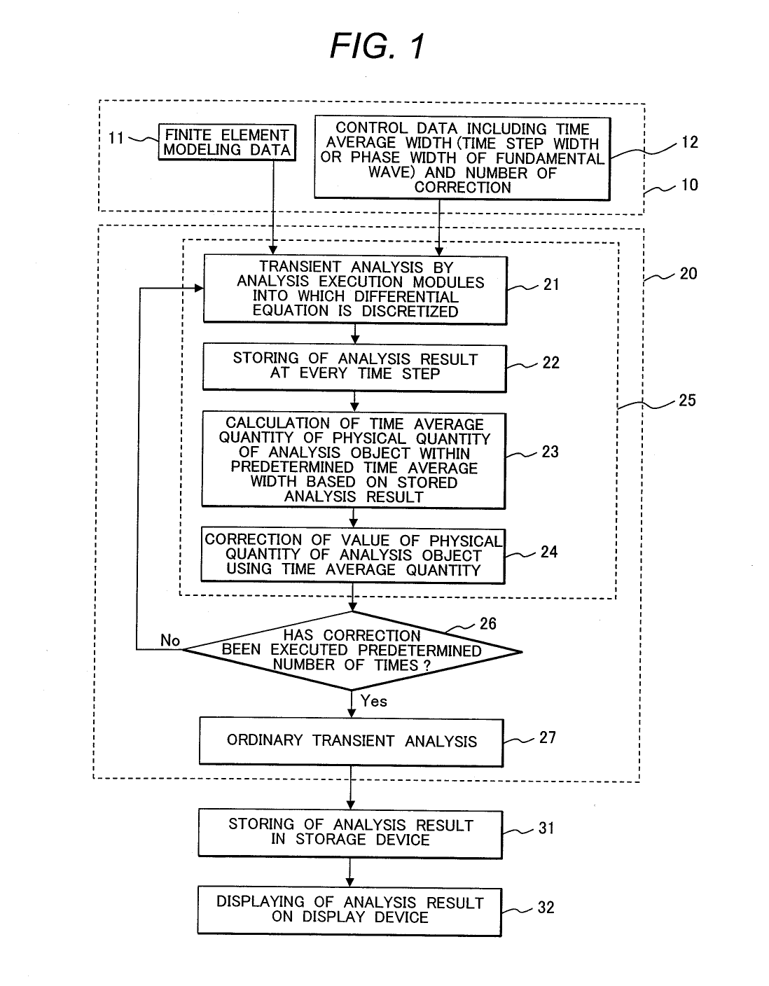

Referring to FIG. 1, a fast analysis method of steady-state fields of the first embodiment in accordance with the present invention will be described below. FIG. 1 shows processes of analysis based on the fast analysis method of steady-state fields according to the present embodiment. The processes of analysis include a process of reading input data 10, an analysis process 20, a storing 31 of analysis results, and a displaying 32 of analysis results. The processes will be described below.

In the process of reading the input data 10, a computer read the input data 10. The input data 10, which is stored in a data file, includes finite element modeling data (mesh data) 11 of an analysis object for numerically solving a differential equation, and control data 12 for controlling the analysis process. The control data 12 includes at least one of a time average width for time averaging on a physical quantity of the analysis object, a phase width of a fundamental wave corresponding to the time average width, and a time step width for the time averaging. The control data 12 also includes the number of corrections, a time step size Δt, and a frequency f of the fundamental wave.

The time step width m is a width (integer value) represented by the number of time steps employed in time averaging. The time average width is a time width employed in the time averaging, and denoted by mΔt using the time step width m and time step size Δt. The phase width of the fundamental wave is obtained by converting the time average width mΔt into a phase width of a fundamental wave, and denoted by ωmΔt. Herein, ω denotes an angular frequency of the fundamental wave, and is calculated as ω=2πf using the frequency f of the fundamental wave.

The control data is, in the present embodiment, stored in the data file and input into the computer. Alternatively, the control data maybe input by a user through a graphic user interface (GUI) or the like of the computer.

In the first embodiment, the process of analysis will be described using the time average width. Using the phase width of a fundamental wave or the time step width allows the analysis to be performed in the same manner. Once one of the values of the time step width m, the time average width mΔt, and the phase width ωmΔt of the fundamental wave is given, the other two values thereof can be obtained using the time step size Δt and the angular frequency ω of the fundamental wave. Therefore, the control data 12 may include any of the time step width m, the time average width mΔt, and the phase width ωmΔt of the fundamental wave.

The analysis process 20 includes a correction process 25 and ordinary transient analysis 27, and is executed by the computer.

In the correction process 25, first of all, transient analysis 21 is executed using analysis execution modules into which a differential equation for obtaining a physical quantity of an analysis object is discretized. The transient analysis 21 is executed according to a conventional method.

The analysis results obtained through the transient analysis 21 are stored through storing of the analysis results 22. During the storing of the analysis results 22, a result of analysis performed on the physical quantity of the analysis object is stored in a memory of the computer at each time step.

Then, calculation 23 of a time average quantity is performed on the physical quantity of the analysis object. During the calculation 23 of a time average quantity, a time average quantity of the physical quantity of the analysis object within a predetermined time average width, which is specified in the control data 12, is calculated based on the stored results of analyses.

The calculated time-averaged physical quantities of the analysis object are used to execute correction 24 of physical quantities of an analysis object. The correction 24 of physical quantities of an analysis object will be described in an embodiment to be introduced later.

In decision 26 on the number of corrections, whether the series of steps included in the correction process 25 has been executed the predetermined number of corrections, which is specified in the control data 12, is decided.

After the correction process 25 is executed the predetermined number of times, ordinary transient analysis 27 is executed in order to obtain a steady-state field for one period.

The obtained analysis results are stored in the storage device by executing the storing 31 of the analysis results. In addition, the analysis results are displayed on the display device by executing the displaying 32 of the analysis results.

The embodiment of the present invention has an advantage that the results of transient analysis are corrected and a result closer to the steady-state field is obtained just after the number of analysis steps equivalent to a predetermined time average width (or a phase width of a fundamental wave or a time step width) are executed.

### Second Embodiment

As the second embodiment of the fast analysis method of steady-state fields in accordance with the present invention, an embodiment about the correction 24 of a physical quantity of an analysis object described in the first embodiment will be described. The correction 24 of a physical quantity is executed using the time-averaged physical quantities of the analysis object obtained by executing the calculation 23 of time-averaged quantities.

As described in the first embodiment, once one of the values of the time step width m, the time average width mΔt, and the phase width ωmΔt of the fundamental wave is given, the other two values thereof can be obtained using the time step size Δt and the angular frequency ω of the fundamental wave.

For convenience in explanations, a description will be made concerning one variable field x(t), where t denotes a time. If a steady-state field is half-periodic, that is, if a condition x(t+T/2)=−x(t) is satisfied, where T denotes a period, the steady-state field only includes odd-order harmonics. In consideration of a decay field with a time constant τ, x(t) is written, for example, as follows:

$$x ( t ) = {a}_{0} {e}^{- \frac{l}{τ} r} + {a}_{1} sin ω t + {b}_{1} cos ω t + {\sum }_{n = 1}^{∝} [ {a}_{n} sin ( 2 n + 1 ) ω t + {b}_{n} cos ( 2 n + 1 ) ω t ] \qquad ( 1 )$$

where a₀ denotes a coefficient of the decay term, a₁ and b₁ denote coefficients for the fundamental wave, aₙ and bₙ denote coefficients for the harmonic, and ω denotes an angular frequency of the fundamental wave.

If the steady-state field is not half-periodic but periodic, that is, if a periodic boundary condition x(t+T)=x(t) is satisfied, where T denotes a period, even-order harmonics are added. In addition, a term a₀ expressing a constant component of a direct current is added. Then, x(t) is written as follows:

$$x ( t ) = {a}_{0} ( 1 - c {e}^{- \frac{1}{τ} z} ) + {a}_{1} sin ω t + {b}_{1} cos ω t + {\sum }_{n = 2}^{∝} ( {a}_{n} sin n ω t + {b}_{n} cos n ω t ) \qquad ( 2 )$$

where c denotes a coefficient.

In order to bring the variable field closer to the steady-state field, a fundamental wave component should be extracted from the transient quantity. The first term on the right side of Eq. (2) is a₀(1−c) at t=0, and the value of the term is transiently changed to a₀. If the time constant τ is long, the value of the term can be approximately regarded as a constant during the period 2π/ω of the fundamental wave. Therefore, when the harmonic component in the fourth term on the right side of Eq. (2) is negligibly small, the equation is written as follows:

x(t)≡a₀(1−c)+a₁ sin ωt+b₁ cos ωt. (3)

By differentiating the equation (3) twice with respect to time, the fundamental wave component can be approximately obtained as follows:

$${a}_{1} sin ω t + {b}_{1} cos ω t ≅ - \frac{{\partial }^{2} x ( t )}{{ω}^{2} \partial {t}^{2}} . \qquad ( 4 )$$

However, in general, the harmonic component in the fourth term on the right side of the equation (2) is not negligible. Therefore, when the fundamental wave component is obtained by differentiating the equation (3) twice with respect to time, the harmonic component gives an unfavorable effect as a noise. Therefore, a time average is calculated over the time period of the primary term of the harmonic component or a time width close to the time period.

The time average will be concretely described below. Assume that xₙ denotes a time-sequential quantity of a physical quantity x(t) at a time tₙ. Assuming that <x(t)> denotes a time average of x(t) and m denotes a time step width over which the time average is obtained, the following equation is written:

$$〈 x ( t ) 〉 = \frac{1}{m + 1} {\sum }_{k = n - m}^{n} {x}_{k} . \qquad ( 5 )$$

This equation brings in the following equation:

$$\frac{{d}^{2} 〈 x ( t ) 〉}{d {t}^{2}} {\vert}_{n - \frac{m}{2} - 1} = \frac{1}{( m + 1 ) {( Δ t )}^{2}} ( {\sum }_{k = n - m}^{n} {x}_{k} - 2 {\sum }_{k = n - m - 1}^{n - 1} {x}_{k} + {\sum }_{k = n - m - 2}^{n - 2} {x}_{k} ) . \qquad ( 6 )$$

The subscript n−(m/2)−1 on the left side of the equation (6) signifies a time step number associated with a second-order derivative value with respect to time. When m is an even number, the time step number is equivalent to the center point of a time zone relating to the summation of the second term in parentheses on the right side. When m is an odd number, the time step number is equivalent to a point near the center point of the time zone relating to the summation of the second term in parentheses on the right side.

Assume that φ denotes a phase width of a time integral for averaging (a phase width of a fundamental wave corresponding to a time average width). When θ=ωt is satisfied and let a phase θ at a current time t be the upper limit of an average integral, the following equations are obtained:

$$\begin{matrix}\frac{1}{ϕ} {\int }_{θ - ϕ}^{θ} sin θ d θ = ( \frac{sin ϕ / 2}{ϕ / 2} ) sin ( θ - \frac{ϕ}{2} ) & ( 7 ) \\ \frac{1}{ϕ} {\int }_{θ - ϕ}^{θ} cos θ d θ = ( \frac{sin ϕ / 2}{ϕ / 2} ) cos ( θ - \frac{ϕ}{2} ) . & ( 8 )\end{matrix}$$

For convenience sake, the phase θ is used instead of the time t. Assuming that x₁(θ) denotes a fundamental wave component of the physical quantity x(θ) and <x₁(θ)> denotes a mean value of x₁(θ), x₁(θ)=a₁ sin θ+b₁ cos θ is satisfied and the following equation is obtained:

$$〈 {x}_{1} ( θ ) 〉 = ( \frac{sin ϕ / 2}{ϕ / 2} ) [ {a}_{1} sin ( θ - \frac{ϕ}{2} ) + {b}_{1} cos ( θ - \frac{ϕ}{2} ) ] . \qquad ( 9 )$$

When Eq. (9) is differentiated twice with respect to the phase θ, the following equation is obtained:

$$\frac{{d}^{2}}{d {θ}^{2}} 〈 {x}_{1} ( θ ) 〉 = - ( \frac{sin ϕ / 2}{ϕ / 2} ) [ {a}_{1} sin ( θ - \frac{ϕ}{2} ) + {b}_{1} cos ( θ - \frac{ϕ}{2} ) ] . \qquad ( 10 )$$

Then, next the following equation is obtained:

$${x}_{1} ( θ - \frac{ϕ}{2} ) = - [ \frac{ϕ / 2}{sin ( ϕ / 2 )} ] \frac{{d}^{2}}{d {θ}^{2}} 〈 {x}_{1} ( θ ) 〉 . \qquad ( 11 )$$

Since the steady-state field has a value close to the fundamental wave component x₁(θ), assuming that x^{old} denotes x before the correction and x^{new} denotes x after the correction, the following equation is obtained:

$${x}^{new} ( θ - \frac{ϕ}{2} ) = - [ \frac{ϕ / 2}{sin ( ϕ / 2 )} ] \frac{{d}^{2}}{d {θ}^{2}} 〈 {x}^{old} ( θ ) 〉 . \qquad ( 12 )$$

According to the equation (12), x can approach the steady-state field. Using the equation (6) and the equation (12), the correction is performed as expressed below.

$${x}_{n - m / 2 - 1}^{new} = - \frac{1}{( m + 1 ) {( ωΔ t )}^{2}} [ \frac{ϕ / 2}{sin ( ϕ / 2 )} ] ( {\sum }_{k = n - m}^{n} {x}_{k}^{old} - 2 {\sum }_{k = n - m - 1}^{n - 1} {x}_{k}^{old} + {\sum }_{k = n - m - 2}^{n - 2} {x}_{k}^{old} ) . \qquad ( 13 )$$

In the right side of the equation (13), (φ/2)/sin(φ/2) is a correction factor.

If the number of harmonics is small, the time average width or the phase width of the fundamental wave may be narrower to perform time averaging. In this case, φ/2<<1 is satisfied and (φ/2)/sin(φ/2) is approximately 1, and therefore the correction coefficient can set to 1.

In this case, x values calculated until time tₙ are used to correct a value at time t_{n-(m/2)-1}. Therefore, the time goes back by (m/2)+1 steps in the correction. Even if the number of steps by which the time goes back is different from (m/2)+1, an effect of correction is exerted accordingly. Therefore, the number of steps by which the time goes back is not limited to (m/2)+1.

If a half-periodic boundary condition is not satisfied and only a periodic boundary condition is satisfied, a solution x₀ to be derived from constant terms, which are included in a source term that excites a field and are constant over time, is obtained in advance. Owing to the correction expressed by the equations (14) and (15),

$$\begin{matrix} {x}^{new} ( θ - \frac{ϕ}{2} ) = {x}_{0} - [ \frac{ϕ / 2}{sin ( ϕ / 2 )} ] \frac{{d}^{2}}{d {θ}^{2}} 〈 {x}^{old} ( θ ) 〉 & ( 14 ) \\ {x}_{n - m / 2 - 1}^{new} = {x}_{0} - \frac{1}{( m + 1 ) {( ωΔ t )}^{2}} [ \frac{ϕ / 2}{sin ( ϕ / 2 )} ] ( {\sum }_{k = n - m}^{n} {x}_{k}^{old} - 2 {\sum }_{k = n - m - 1}^{n - 1} {x}_{k}^{old} + {\sum }_{k = n - m - 2}^{n - 2} {x}_{k}^{old} ) , & ( 15 )\end{matrix}$$

the physical quantity can rapidly approach the steady-state field. Even in this case, the number of steps by which the time goes back is not limited to (m/2)+1.

In order to present a specific effect of the correction, a sample model of simultaneous differential equations will be discussed with respect to two variables x and y. As an example, simultaneous differential equations having eleventh-order and thirteenth-order harmonics in a source term are discussed. The simultaneous differential equations are as follows:

$$( \begin{matrix}2 & - 1 \\ - 1 & 2\end{matrix} ) ( \begin{matrix}x \\ y\end{matrix} ) + 5 ( \begin{matrix}\frac{d x}{d t} \\ \frac{d y}{d t}\end{matrix} ) = ( \begin{matrix}0 \\ {a}_{1} sin t + {a}_{2} sin 11 t + {a}_{3} sin 13 t\end{matrix} ) . \qquad ( 16 )$$

The theoretical steady-state solutions xₚ and yₚ are expressed by

$${x}_{p} = {\sum }_{n = 1}^{3} {a}_{n} ( {f}_{1 n} sin θ + {g}_{1 n} cos θ ) , \\ {y}_{p} = {\sum }_{n = 1}^{3} {a}_{n} ( {f}_{2 n} sin θ + {g}_{2 n} cos θ ) \qquad ( 17 )$$

wherein

$$\begin{matrix}{f}_{11} = - \frac{11}{442} , {g}_{11} = - \frac{10}{442} , {f}_{21} = \frac{28}{442} , {g}_{21} = - \frac{75}{442} & ( 18 ) \\ {f}_{12} = - \frac{1511}{4590442} , {g}_{12} = - \frac{110}{4590442} , \\ {f}_{22} = \frac{3028}{4590442} , {g}_{22} = - \frac{83325}{4590442} & ( 19 ) \\ {f}_{13} = - \frac{2111}{8946442} , {g}_{13} = - \frac{130}{8946442} , \\ {f}_{23} = \frac{4228}{8946442} , {g}_{23} = - \frac{137475}{8946442} . & ( 20 )\end{matrix}$$

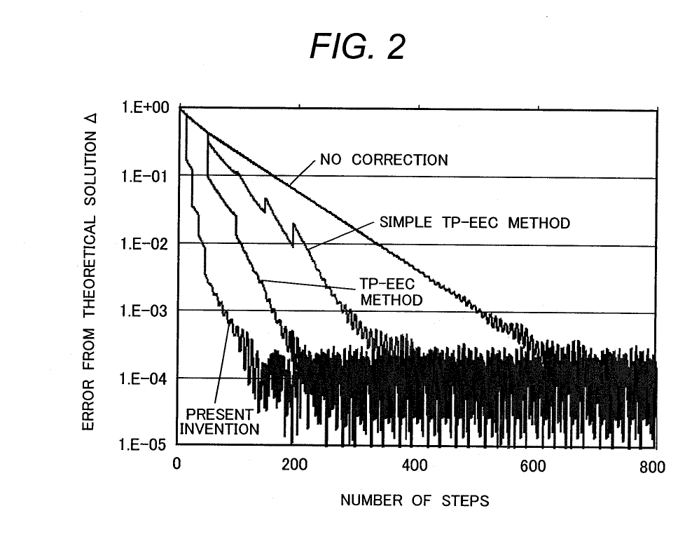

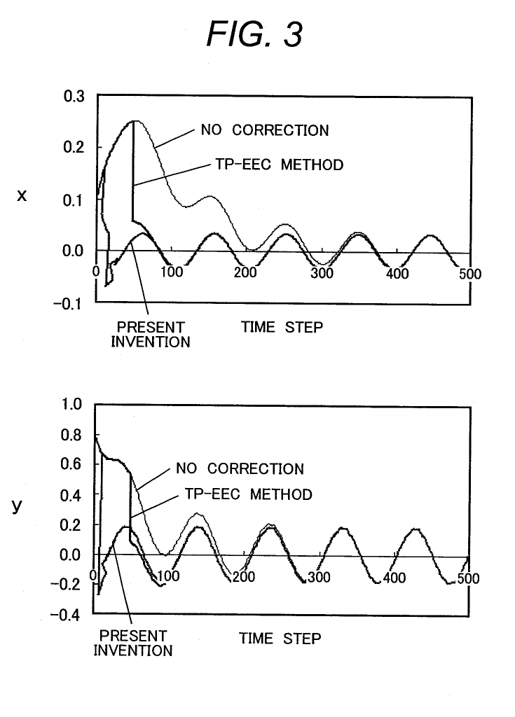

FIG. 2 and FIG. 3 show results of calculations in a case where a₁=1, a₂=¼, and a₃= 1/16, and x=0.1 and y=0.8 as initial values are assigned to the equations (17) to (20).

FIG. 2 shows time variations of an error Δ from the theoretical steady-state solution in four cases where no correction is performed, correction is performed according to a simple TP-EEC method, correction is performed according to the TP-EEC method, and correction is performed according to the present invention (each correction is performed three times). The error Δ is defined with an equation (21):

Δ=\sqrt{(x−xₚ)²+(y−yₚ)²}. (21)

FIG. 2 shows that, compared with the corrections according to the simple TP-EEC method and TP-EEC method, the correction according to the present invention enables a physical quantity to approach the steady-state field most rapidly by the smallest number of steps.

FIG. 3 shows time variations of the variables x and y in three cases where no correction is performed, correction is performed according to the TP-EEC method, and correction is performed according to the present invention (each correction is performed three times). FIG. 3 shows that the correction according to the present invention can early obtain the steady-state field by a smaller number of time steps.

According to the present embodiment, the correction can be achieved by performing transient analysis over (m+2) steps that is the sum of 2 and the time step width m. The time step width is a value almost equivalent to the period of the primary term of the harmonics. Therefore, the present embodiment has an advantage that a fast shift to a steady-state field can be achieved, resulting in a reduced calculation time and a very low calculation cost.

### Third Embodiment

A fast analysis method of steady-state fields of the third embodiment in accordance with the present invention employs another calculation method of a time derivative in the fast analysis method of steady-state fields of the second embodiment.

Differentiating the equation (9) once with respect to the phase θ leads to the following equation:

$$\frac{d}{d θ} 〈 {x}_{1} ( θ ) 〉 = ( \frac{sin ϕ / 2}{ϕ / 2} ) [ {a}_{1} cos ( θ - \frac{ϕ}{2} ) - {b}_{1} sin ( θ - \frac{ϕ}{2} ) ] . \qquad ( 22 )$$

Using the equations (10) and (22), two equations of x₁ are obtained as follows:

$$\begin{matrix}{x}_{1} ( θ ) = - ( \frac{ϕ}{2} ) [ cot ( \frac{ϕ}{2} ) \frac{{d}^{2}}{d {θ}^{2}} 〈 {x}_{1} ( θ ) 〉 - \frac{d}{d θ} 〈 {x}_{1} ( θ ) 〉 ] & ( 23 ) \\ {x}_{1} ( θ - ϕ ) = - ( \frac{ϕ}{2} ) [ cot ( \frac{ϕ}{2} ) \frac{{d}^{2}}{d {θ}^{2}} 〈 {x}_{1} ( θ ) 〉 + \frac{d}{d θ} 〈 {x}_{1} ( θ ) 〉 ] . & ( 24 )\end{matrix}$$

The equations (23) and (24) lead to corrections expressed by the following equations:

$$\begin{matrix}{x}^{new} ( θ ) = - ( \frac{ϕ}{2} ) [ cot ( \frac{ϕ}{2} ) \frac{{d}^{2}}{d {θ}^{2}} 〈 {x}^{old} ( θ ) 〉 - \frac{d}{d θ} 〈 {x}^{old} ( θ ) 〉 ] & ( 25 ) \\ {x}^{new} ( θ - ϕ ) = - ( \frac{ϕ}{2} ) [ cot ( \frac{ϕ}{2} ) \frac{{d}^{2}}{d {θ}^{2}} 〈 {x}^{old} ( θ ) 〉 + \frac{d}{d θ} 〈 {x}^{old} ( θ ) 〉 ] . & ( 26 )\end{matrix}$$

When time axes of the equations (25) and (26) are discretized,

$$\begin{matrix}{x}_{n - 1}^{new} = - \frac{ϕ}{2 ( m + 1 )} \times [ \begin{matrix}\frac{cot ( ϕ / 2 )}{{( ωΔ t )}^{2}} ( \begin{matrix}{\sum }_{k = n - m}^{n} {x}_{k}^{old} - \\ 2 {\sum }_{k = n - m - 1}^{n - 1} {x}_{k}^{old} + \\ {\sum }_{k = n - m - 2}^{n - 2} {x}_{k}^{old}\end{matrix} ) - \\ \frac{1}{2 ωΔ t} ( {\sum }_{k = n - m}^{n} {x}_{k}^{old} - {\sum }_{k = n - m - 2}^{n - 2} {x}_{k}^{old} )\end{matrix} ] & ( 27 ) \\ {x}_{n - m - 2}^{new} = - \frac{ϕ}{2 ( m + 1 )} \times [ \begin{matrix}\frac{cot ( ϕ / 2 )}{{( ωΔ t )}^{2}} ( \begin{matrix}{\sum }_{k = n - m}^{n} {x}_{k}^{old} - \\ 2 {\sum }_{k = n - m - 1}^{n - 1} {x}_{k}^{old} + \\ {\sum }_{k = n - m - 2}^{n - 2} {x}_{k}^{old}\end{matrix} ) + \\ \frac{1}{2 ωΔ t} ( {\sum }_{k = n - m}^{n} {x}_{k}^{old} - {\sum }_{k = n - m - 2}^{n - 2} {x}_{k}^{old} )\end{matrix} ] & ( 28 )\end{matrix}$$

are obtained.

In the case of the equation (27), x values calculated until time tₙ are used to correct a value obtained at time tₙ₋₁. Therefore, the time goes back by one step in the correction. In the case of the equation (28), x values calculated until time tₙ are used to correct a value obtained at time tₙ₋ₘ₋₂. Therefore, the time goes back by m+2 steps in the correction. The number of steps by which the time goes back is not limited to the numbers of steps introduced here.

The calculation method employed in the present embodiment has an advantage that a stronger effect of correction can be exerted in some cases over the calculation method employed in the second embodiment.

### Forth Embodiment

A fast analysis method of steady-state fields of the forth embodiment in accordance with the present invention employs another calculation method of a time derivative other than the calculation method employed in the fast analysis method of steady-state fields of the second or third embodiment.

From the equation (6), the following equations are derived:

$$\begin{matrix} \frac{d}{d θ} 〈 {x}_{1} ( θ ) 〉 = ( \frac{sin ϕ / 2}{ϕ / 2} ) [ {a}_{1} sin ( θ - \frac{ϕ}{2} + \frac{π}{2} ) + {b}_{1} cos ( θ - \frac{ϕ}{2} + \frac{π}{2} ) ] & ( 29 ) \\ \frac{d}{d θ} 〈 {x}_{1} ( θ ) 〉 = - ( \frac{sin ϕ / 2}{ϕ / 2} ) [ {a}_{1} sin ( θ - \frac{ϕ}{2} - \frac{π}{2} ) + {b}_{1} cos ( θ - \frac{ϕ}{2} - \frac{π}{2} ) ] . & ( 30 )\end{matrix}$$

The equations are rewritten as follows:

$$\begin{matrix}{x}_{1} ( θ - \frac{ϕ}{2} + \frac{π}{2} ) = ( \frac{ϕ / 2}{sin ϕ / 2} ) \frac{d}{d θ} 〈 {x}_{1} ( θ ) 〉 & ( 31 ) \\ {x}_{1} ( θ - \frac{ϕ}{2} + \frac{π}{2} ) = ( \frac{ϕ / 2}{sin ϕ / 2} ) \frac{d}{d θ} 〈 {x}_{1} ( θ ) 〉 . & ( 32 )\end{matrix}$$

From the above equations, the following correction equations are derived:

$$\begin{matrix}{x}^{new} ( θ - \frac{ϕ}{2} + \frac{π}{2} ) = ( \frac{ϕ / 2}{sin ϕ / 2} ) \frac{d}{d θ} 〈 {x}^{old} ( θ ) 〉 & ( 33 ) \\ {x}^{new} ( θ - \frac{ϕ}{2} - \frac{π}{2} ) = - ( \frac{ϕ / 2}{sin ϕ / 2} ) \frac{d}{d θ} 〈 {x}^{old} ( θ ) 〉 . & ( 34 )\end{matrix}$$

Assuming that N denotes the number of time divisions of the period of a fundamental wave, when the equations (33) and (34) are changed to expressions having discretized time axes, the following equations are obtained:

$$\begin{matrix} {x}_{n - m / 2 + N / 4}^{new} = \frac{1}{2 ( m + 1 ) ωΔ t} ( \frac{ϕ / 2}{sin ϕ / 2} ) ( {\sum }_{k = n - m}^{n} {x}_{k}^{old} - {\sum }_{k = n - m - 2}^{n - 2} {x}_{k}^{old} ) & ( 35 ) \\ {x}_{n - m / 2 - N / 4}^{new} = - \frac{1}{2 ( m + 1 ) ωΔ t} ( \frac{ϕ / 2}{sin ϕ / 2} ) ( {\sum }_{k = n - m}^{n} {x}_{k}^{old} - {\sum }_{k = n - m - 2}^{n - 2} {x}_{k}^{old} ) . & ( 36 )\end{matrix}$$

The equation (35) signifies a correction at a time when the time goes ahead by N/4−m/2. The equation (36) signifies a correction at a time when the time goes back by N/4+m/2. The number of steps by which the time goes ahead or back is not limited to the number of steps introduced here.

The calculation method employed in the present embodiment has an advantage that a stronger effect of correction can be exerted in some cases over the calculation method employed in the second or third embodiment.

### Fifth Embodiment

In the fifth embodiment of the fast analysis method of steady-state fields in accordance with the present invention, the fast analysis method of one of the first to forth embodiments is applied to a magnetic field analysis.

As a typical analysis technique, the finite element method employing a magnetic vector potential will be described below. In the nodal-element finite element method, unknown variables (Axⱼ, Ayⱼ, Azⱼ) of three vector components are assigned to each node in an discretized analytical space. In the edge-element finite element method, an unknown variable aⱼ is assigned to an j-th edge of each element in the discretized analytical space. The unknown variable aⱼ in the edge-element finite element method is a line integral quantity of a projection of a magnetic vector potential onto an edge of each element, the integration being performed over the edge.

On the unknown variables of the physical quantities, the same correction as that on the physical quantity x in the second embodiment is performed. Specifically, the results of transient analysis are used to perform the correction, which is expressed by any one of Eqs. (13), (27), (28), (35), and (36), on each of the unknown variables. The correction is performed once or plural times. For the series of the corrections, one of the above equations may be adopted or a combination of different ones may be adopted.

In a case of a rotating machine (a motor or a generator), since an electromagnetic field induced in a stator is an alternating field, in which the direction of the magnetic field is reversed, a half-periodic boundary condition is satisfied. On the other hand, a rotor may be provided with a magnet or an excitation coil into which a direct current flows. In this case, a DC component of a magnetic field exists in the rotor. Because of a fluctuation of a magnetic circuit caused by rotation of the rotor, slot harmonics that is generated with rotational movement of slots among teeth of the stator exists in the DC component of the magnetic field in the rotor. In this case, in the rotor, inducing a magnetic field having an AC component superposed on the DC component, the half-periodic boundary condition is not satisfied and a periodic boundary condition is satisfied.

Therefore, in a magnetic field analysis for the rotating machine, correction associated with the half-periodic boundary condition is performed for the stator, and correction associated with the periodic boundary condition is performed for the rotor. Then, a steady-state field is speedily obtained. Incidentally, since the slot harmonic on the magnetic field of the rotor is a small vibration, the correction may not be performed for the rotor and the correction may be performed only for the stator. Nevertheless, the steady-state field can be obtained at a satisfactorily high speed.

In an induction motor that utilizes rotary drive by an eddy current, a rotor rotates at a slower rotation frequency than a rotating magnetic field does. The difference between the frequencies is called a slip frequency. In order to quickly obtain a steady-state field in the induction motor, the correction is performed with the slip frequency regarded as a fundamental-wave frequency.

In the application examples to magnetic field analysis of the fast analysis method of steady-state fields in accordance with the present invention, which are presented in the present embodiment, there are advantages that a magnetic-field distribution close to a steady-state field is obtained and that a calculation time necessary to converge to the steady-state field is largely shortened. In addition, since the correction can be readily executed using a second-order derivative value with respect to time of averaged quantity of time, a calculation cost is an almost nil.

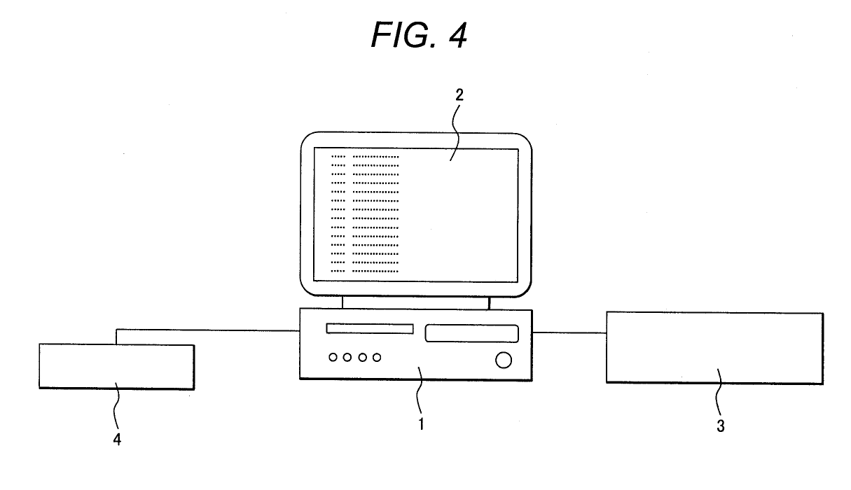

FIG. 4 shows an example of an analysis system in which the first to fifth embodiments of the present invention are implemented. The analysis system includes a computer 1, a display device 2, a storage device 3, and an input device 4. In FIG. 4, the storage device 3 is shown outside of the computer 1 for explicit illustration. Alternatively, the storage device 3 may be installed inside of the computer 1.

The computer 1 stores a fast analysis program of steady-state fields in which a series of processes is coded, including at least one of the fast analysis methods of steady-state fields of the first to fifth embodiments. The fast analysis program of steady-state fields can be recorded in a computer-readable recording medium. The computer 1 can load the fast analysis program of steady-state fields via the computer-readable recording medium in which the fast analysis program of steady-state fields is recorded. The input device 4 includes a keyboard and a mouse, for example, and is used for inputting input data necessary to analysis into the computer 1, designating read/write of a data file storing the input data, or executing a calculation.

When input data is input, the computer 1 executes reading of the input data and arithmetic processing such as a steady-state field calculation according to the stored fast analysis program of steady-state fields. The results of the calculation are displayed on the display device 2 and stored as a data file in the storage device 3. Part of the obtained results of calculation may be displayed or stored.

What is claimed is:

1. A fast analysis method of steady-state fields by an arithmetic device, for performing arithmetic processing over a plurality of time steps, performing transient analysis on the basis of an equation having a time derivative term, and obtaining a physical quantity of an analysis object, comprising the steps of:
reading input data including a time average width necessary to perform time averaging on the physical quantity, a phase width of a fundamental wave corresponding to the time average width, or a number of time steps width necessary to perform the time averaging, and finite element modeling data of the analysis object by the arithmetic device;
obtaining time-averaged physical quantities using the time average width, the phase width of the fundamental wave, or the time step width by the arithmetic device; and
obtaining a steady-state field of the physical quantity through a correction of the physical quantity using the time average quantity by the arithmetic device.

2. A fast analysis method of steady-state fields by an arithmetic device, for performing arithmetic processing over a plurality of time steps, performing transient analysis on the basis of an equation having a time derivative term, and obtaining a physical quantity of an analysis object, comprising the steps of:
reading input data including a time average width necessary to perform time averaging on the physical quantity, a phase width of a fundamental wave corresponding to the time average width, or a number of time steps width necessary to perform the time averaging, and finite element modeling data of the analysis object by the arithmetic device;
obtaining time-averaged physical quantities using the time average width or the time step width by the arithmetic device; and
obtaining a steady-state field of the physical quantity through a correction of the physical quantity using the time average quantity by the arithmetic device.

3. A fast analysis method of steady-state fields by an arithmetic device, for performing transient analysis on a nonlinear magnetic field of an analysis object by finite element method and arithmetic processing over a plurality of time steps, comprising the steps of:
reading input data including a time average width necessary to perform time averaging on an unknown variable employed in magnetic field analysis, a phase width of a fundamental wave corresponding to the time average width, or a time step width necessary to perform the time averaging, and finite element modeling data of the analysis object by the arithmetic device;
obtaining a time average quantity of a value of the unknown variable obtained through the transient analysis using the time average width, the phase width of the fundamental wave, or the time step width by the arithmetic device; and
obtaining a steady-state field of the nonlinear magnetic field through a correction of the value of the unknown variable obtained through the transient analysis using the time average quantity by the arithmetic device.

4. The fast analysis method of steady-state fields according to claim 3, wherein edge-element finite element method is adopted as the finite element method.

5. The fast analysis method of steady-state fields according to claim 1, wherein:
the correction is to transform the physical quantity by obtaining a second-order derivative of the time average quantity with respect to time, multiplying a value of the second-order derivative by −1, and multiplying the multiplied value of the second-order derivative by a correction coefficient; and
the arithmetic device executes the correction once or a plurality of times.

6. The fast analysis method of steady-state fields according to claim 2, wherein:
the correction is to transform the physical quantity by obtaining a second-order derivative of the time average quantity with respect to time, multiplying a value of the second-order derivative by −1, and multiplying the multiplied value of the second-order derivative by a correction coefficient; and
the arithmetic device executes the correction once or a plurality of times.

7. The fast analysis method of steady-state fields according to claim 3, wherein:
the correction is to transform the value of the unknown variable obtained through the transient analysis by obtaining a second-order derivative of the time average quantity with respect to time, multiplying a value of the second-order derivative by −1, and multiplying the multiplied value of the second-order derivative by a correction coefficient; and
the arithmetic device executes the correction once or a plurality of times.

8. The fast analysis method of steady-state fields according to claim 5, wherein:
the arithmetic device computes a half of the phase width of the fundamental wave as a width φh using the time average width, the phase width of the fundamental wave, or the time step width; and
the correction coefficient is 1 or φh/sin φh.

9. The fast analysis method of steady-state fields according to claim 6, wherein:
the arithmetic device computes a half of the phase width of the fundamental wave as a width φh using the time average width, the phase width of the fundamental wave, or the time step width; and
the correction coefficient is 1 or φh/sin φh.

10. The fast analysis method of steady-state fields according to claim 7, wherein:
the arithmetic device obtains a half of the phase width of the fundamental wave as a width φh using the time average width, the phase width of the fundamental wave, or the time step width; and
the correction coefficient is 1 or φh/sin φh.

11. A fast analysis program of steady-state fields in which a series of steps included in the fast analysis method of steady-state fields according to claim 1 is coded.

12. A fast analysis program of steady-state fields in which a series of steps included in the fast analysis method of steady-state fields according to claim 2 is coded.

13. A fast analysis program of steady-state fields in which a series of steps included in the fast analysis method of steady-state fields according to claim 3 is coded.

14. A computer-readable recording medium in which the fast analysis program of steady-state fields according to claim 11 is recorded.

15. A computer-readable recording medium in which the fast analysis program of steady-state fields according to claim 12 is recorded.

16. A computer-readable recording medium in which the fast analysis program of steady-state fields according to claim 13 is recorded.
